(19) United States
(12) Patent Application Publication
(10) Pub. No.: US 2020/0158038 A1
(43) Pub. Date: May 21, 2020

(54) PRE-COMPRESSOR VALVE EQUIPPED LOW PRESSURE COOLED EXHAUST GAS RECIRCULATION TRACKING ERROR MANAGEMENT

(71) Applicants: Shu Wang, Rochester Hills, MI (US); Ethan E. Bayer, Lake Orion, MI (US); William P. Attard, Brighton, MI (US); David Lawrence, Lake Orion, MI (US)

(72) Inventors: Shu Wang, Rochester Hills, MI (US); Ethan E. Bayer, Lake Orion, MI (US); William P. Attard, Brighton, MI (US); David Lawrence, Lake Orion, MI (US)

(21) Appl. No.: 16/681,344

(22) Filed: Nov. 12, 2019

Related U.S. Application Data
(60) Provisional application No. 62/768,260, filed on Nov. 16, 2018.

(51) Int. Cl. F02D 41/00; F02B 25/14; F01N 3/023; B60W 10/30

(52) U.S. Cl. CPC F02D 41/0077; F02B 25/145; B60W 2540/10; B60W 10/30; F01N 3/0236

(57) ABSTRACT

Engine low pressure cooled exhaust gas recirculation (LPCEGR) control techniques comprise receiving a measured position of an accelerator pedal and, based on this measurement, detecting a transient tip-out event or a transient tip-in event. In response to detecting the transient tip-out event, an EGR depletion rate is temporarily increased by at least one of (i) downstream throttle valve control to maintain at least a minimum engine airflow or to regulate a rate of decrease of the airflow into the engine, (ii) cylinder bank fuel shutoff, and (iii) pre-scheduled EGR valve control based on the measured accelerator pedal position. In response to detecting the transient tip-in event, an EGR delivery rate is temporarily increased by at least one of (i) the pre-scheduled EGR valve control and (ii) controlling intake/exhaust valves of cylinders of the engine to enable a scavenging mode.

### CROSS-REFERENCE TO RELATED APPLICATION(S)

The present application claims the benefit of U.S. Provisional Application No. 62/768,260, filed on Nov. 16, 2018. The disclosure of the above-identified application is incorporated herein by reference in its entirety.

### FIELD

The present application generally relates to exhaust gas recirculation (EGR) and, more particularly, to techniques for managing EGR tracking error in a turbocharged engine having a low pressure cooled EGR (LPCEGR) system.

### BACKGROUND

Exhaust gas recirculation (EGR) involves recirculating at least a portion of the exhaust gas produced by an engine back into an induction system of the engine. EGR is typically used to reduce nitrogen oxide (NOx) emissions, to reduce pumping losses and increase engine efficiency, and/or to reduce knock/auto-ignition. In a low pressure cooled EGR (LPCEGR) system, exhaust gas is recirculated from a point after a turbine of a turbocharger through an EGR loop where it is cooled by an EGR cooler and then reintroduced into an induction system at a point before a compressor of the turbocharger. The length of the EGR and induction loops in an LPCEGR system are often quite long and have a large volume, which results in a large EGR transport delay and makes it difficult for accurate EGR tracking. During transient conditions, for example, the desired in-cylinder EGR is not immediately achievable due to this EGR transport delay. Further, there is the possibility of under-delivering or over-delivering EGR when conditions are quickly changing. Accordingly, while such EGR systems do work for their intended purpose, there remains a need for improvement in the relevant art.

### SUMMARY

According to one example aspect of the invention, a control system for a turbocharged engine having a low pressure cooled exhaust gas recirculation (LPCEGR) system configured to provide EGR to an induction system of the engine via an EGR port is presented. In one exemplary implementation, the control system comprises: an accelerator pedal position sensor configured to measure a position of an accelerator pedal of a vehicle comprising the engine, and a controller configured to detect a transient tip-out event or a transient tip-in event based on the measured accelerator pedal position and: in response to detecting the transient tip-out event, temporarily increase an EGR depletion rate by at least one of: (i) controlling a throttle valve arranged downstream from the EGR port to maintain at least a minimum airflow into the engine or to regulate a rate of decrease of the airflow into the engine, (ii) disabling fueling to a first cylinder bank of the engine, and (iii) controlling an EGR valve of the LPCEGR system to pre-schedule EGR based on the measured accelerator pedal position, and in response to detecting the transient tip-in event, temporarily increase an EGR delivery rate by at least one of: (i) controlling the EGR valve to pre-schedule EGR based on the measured accelerator pedal position, and (ii) controlling intake/exhaust valves of cylinders of the engine to enable a scavenging mode.

In some implementations, in response to detecting the transient tip-out event, the controller is further configured to temporarily compensate for excessive EGR by at least one of: (i) optimizing intake/exhaust camshaft positions to at least one of minimize in-cylinder residual gas and increase intake charge motion for better air/fuel mixing and turbulence kinetics, and (ii) optimizing at least one of spark timing and spark energy. In some implementations, in response to detecting the transient tip-in event, the controller is further configured to temporarily compensate for insufficient EGR by optimizing at least one of spark timing and spark energy. In some implementations, the controller is configured to disable fueling to the first cylinder bank of the engine while still allowing airflow through the first cylinder bank and also maintaining fueling to a different second cylinder bank. In some implementations, the controller is configured to control the EGR valve to pre-schedule EGR based on the measured accelerator pedal position in advance of one or more other engine flow-control actuators. In some implementations, the controller is configured to temporarily increase the EGR depletion rate in response to detecting the transient tip-out event to at least one of (i) maintain or increase combustion quality/stability and (ii) mitigate or prevent engine misfires.

In some implementations, the controller is configured to temporarily increase the EGR delivery rate in response to detecting the transient tip-in event to at least one of (i) mitigate or prevent pre-ignition/knock and (ii) maintain or increase engine fuel economy. In some implementations, the controller is configured to temporarily increase the EGR depletion rate in response to detecting the transient tip-out event by: (i) controlling the throttle valve to maintain at least the minimum airflow into the engine or to regulate the rate of decrease of the airflow into the engine, (ii) disabling fueling to the first cylinder bank of the engine, and (iii) controlling the EGR valve to pre-schedule EGR based on the measured accelerator pedal position. In some implementations, the controller is configured to temporarily increase the EGR delivery rate in response to detecting the transient tip-in event by: (i) controlling the EGR valve to pre-schedule EGR based on the measured accelerator pedal position, and (ii) controlling the intake/exhaust valves of the cylinders of the engine to enable the scavenging mode.

According to another example aspect of the invention, a control method for a turbocharged engine having an LPCEGR system configured to provide EGR to an induction system of the engine via an EGR port is presented. In one exemplary implementation, the method comprises: receiving, by a controller of the engine and from an accelerator pedal position sensor, a measured position of an accelerator pedal of a vehicle comprising the engine, detecting, by the controller, a transient tip-out event or a transient tip-in event based on the measured accelerator pedal position, in response to detecting the transient tip-out event, temporarily increase an EGR depletion rate by at least one of: (i) controlling a throttle valve arranged downstream from the EGR port to maintain at least a minimum airflow into the engine or to regulate a rate of decrease of the airflow into the engine, (ii) disabling fueling to a first cylinder bank of the engine, and (iii) controlling an EGR valve of the LPCEGR system to pre-schedule EGR based on the measured accelerator pedal position, and in response to detecting the transient tip-in event, temporarily increase an EGR delivery rate by at least one of: (i) controlling the EGR valve to pre-schedule EGR based on the measured accelerator pedal position, and (ii) controlling intake/exhaust valves of cylinders of the engine to enable a scavenging mode.

In some implementations, the method further comprises in response to detecting the transient tip-out event, temporarily compensating for excessive EGR, by the controller, by at least one of: (i) optimizing intake/exhaust camshaft positions to at least one of minimize in-cylinder residual gas and increase intake charge motion for better air/fuel mixing and turbulence kinetics, and (ii) optimizing at least one of spark timing and spark energy. In some implementations, the method further comprises in response to detecting the transient tip-in event, temporarily compensating for insufficient EGR. by the controller, by optimizing at least one of spark timing and spark energy. In some implementations, disabling fueling to the first cylinder bank of the engine further comprises still allowing airflow through the first cylinder bank and also maintaining fueling to a different second cylinder bank. In some implementations, controlling the EGR valve to pre-schedule EGR based on the measured accelerator pedal position is performed in advance of one or more other engine flow-control actuators.

In some implementations, temporarily increasing the EGR depletion rate in response to detecting the transient tip-out event is performed to at least one of (i) maintain or increase combustion quality/stability and (ii) mitigate or prevent engine misfires. In some implementations, temporarily increasing the EGR delivery rate in response to detecting the transient tip-in event is performed to at least one of (i) mitigate or prevent pre-ignition/knock and (ii) maintain or increase engine fuel economy. In some implementations, temporarily increasing the EGR depletion rate in response to detecting the transient tip-out event comprises: (i) controlling the throttle valve to maintain at least the minimum airflow into the engine or to regulate the rate of decrease of the airflow into the engine, (ii) disabling fueling to the first cylinder bank of the engine, and (iii) controlling the EGR valve to pre-schedule EGR based on the measured accelerator pedal position. In some implementations, temporarily increasing the EGR delivery rate in response to detecting the transient tip-in event comprises: (i) controlling the EGR valve to pre-schedule EGR based on the measured accelerator pedal position, and (ii) controlling the intake/exhaust valves of the cylinders of the engine to enable the scavenging mode.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example vehicle having a turbocharged engine with a low pressure, cooled exhaust gas recirculation (LPCEGR) system according to the principles of the present disclosure;

FIGS. 2A-2D are functional block diagrams of example control architectures for improving EGR tracking error in engines having LPCEGR systems according to the principles of the present disclosure; and

FIG. 3 is a flow diagram of an example method of controlling a turbocharged engine having an LPCEGR system to mitigate or prevent under-delivery or over-delivery of EGR during transient accelerator pedal tip-in and tip-out events according to the principles of the present disclosure.

### DETAILED DESCRIPTION

As previously discussed, low pressure cooled exhaust gas recirculation (LPCEGR) systems for turbocharged engines require accurate EGR tracking, but this is difficult due to the large EGR transport delay in these systems, particularly during transient operating conditions. For example, when a driver tips-out an accelerator pedal, EGR could be over-delivered and cause combustion instability and potential misfires. Similarly, for example, when the driver tips-in the accelerator pedal, EGR could be under-delivered and potentially cause pre-ignition/knock, and decreased fuel economy. Accordingly, techniques are presented for more accurate EGR tracking in a turbocharged engine having an LPCEGR system. These techniques include one or more of the following: (1) air flow regulation, because low engine loads have less EGR tracking error tolerance and slower EGR depletion rates, (2) cylinder bank fuel shutoff, which results in a higher higher engine flow rate for the same engine load, (3) acceleration pedal based EGR scheduling instead of air flow based EGR scheduling, and (4) scavenging to increase engine and EGR flow.

In some implementations, the air flow regulation and/or cylinder bank fuel shutoff could be performed in response to accelerator pedal tip-out whereas the accelerator pedal based EGR scheduling and/or scavenging could be performed in response to accelerator pedal tip-in. Any remaining EGR tracking error is then handled via camshaft optimization and/or spark optimization. For example, for EGR over-delivery caused by accelerator pedal tip-out, intake and exhaust camshafts could be optimized to minimize internal residual gas and increase intake charge motion for better fuel/air mixing and turbulence kinetics to reduce potential misfires, as well as spark timing could be optimized to compensate for over-delivered EGR to reduce potential combustion issues. Also, for example, for EGR under-delivery caused by accelerator pedal tip-in, only spark adjustment could be used to compensate for under-delivered EGR to mitigate potential pre-ignition/knock.

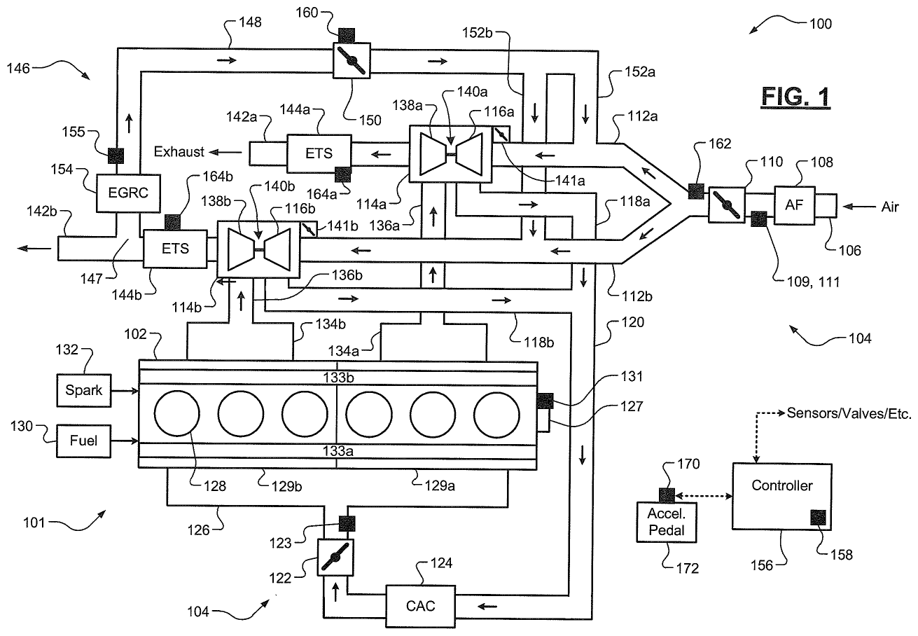

Referring now to FIG. 1, an example engine system 101 for a vehicle or vehicle powertrain 100 is illustrated. The engine system 101 includes an internal combustion engine 102 that receives air from an induction system 104. While a gasoline internal combustion engine is specifically illustrated and discussed herein, it will be appreciated that the techniques of the present disclosure could also be applicable to other internal combustion engines having LPCEGR systems (e.g., diesel engines). An induction path 106 receives fresh air that is filtered by an air filter (AF) 108. A differential pressure (dP) valve 110 regulates the flow of air through the induction path 106 and a pressure in induction paths 112a, 112b. Turbochargers 114a, 114b comprise compressors 116a, 116b (“compressors 116”) that force air/exhaust gas from the induction paths 112a, 112b through induction paths 118a, 118b that converge into a single induction path 120. While two turbochargers 114a and 114b are shown, it will be appreciated that the engine system 101 could have only one turbocharger and associated piping or a different boost device/system, such as a supercharged configuration. A throttle valve 122 regulates the flow of air/exhaust gas through a CAC 124 and into an intake manifold 126. It will be appreciated that the throttle 122 could be implemented upstream from the CAC 124. The air/exhaust gas in the intake manifold 126 is provided to a plurality of cylinders 128, combined with gasoline from a fuel system 130 and combusted by spark from spark plugs 132 to drive pistons (not shown) that generate drive torque at a crankshaft 127. The cylinders 128 are divided into two banks 129a, 129b. While six cylinders (three cylinders per bank) are shown, it will be appreciated that the engine 102 could include any suitable number of cylinders (4, 8, etc.). An engine speed sensor 131 measures a rotational speed of the crankshaft 127, also known as a speed of the engine 102. Air flow into the cylinders 128 is controlled via an intake control system 133a, which could comprise an intake camshaft (e.g., having different lift profiles) and intake valves for each cylinder 128.

In one exemplary implementation, the fuel system 130 comprises a fuel tank that houses fuel (e.g., gasoline), a fuel rail that houses pressurized fuel, fuel injectors that open/close to inject the pressurized fuel into the engine 102, and a fuel pump that pumps the fuel from the fuel tank to the fuel rail to generate the pressurized fuel. The fuel system 130 could also optionally include an evaporative emissions (EVAP) system that captures fuel or “purge” vapor that evaporates from the fuel in the fuel tank and stores it in a vapor canister and provides the fuel vapor to any suitable point in the induction system 104 (e.g., after the dP valve 110) via an EVAP line and a purge valve. Fuel vapor is highly combustible and therefore is able to increase engine power and/or efficiency. Exhaust gas resulting from combustion is expelled from the cylinders 128 into exhaust manifolds 134a, 134b. Each exhaust manifold 134a, 134b, for example, could be associated with cylinder banks 129a, 129b, respectively. Exhaust gas flow out of the cylinders 128 is controlled via an exhaust control system 133b, which could include an exhaust camshaft (e.g., having different lift profiles) and exhaust valves for each cylinder 128. The exhaust gas in exhaust manifold 134a flows through exhaust path 136a and its kinetic energy drives a turbine 138a of turbocharger 114a. The turbine 138a drives compressor 116a via a shaft 140a. Similarly, the exhaust gas in exhaust manifold 134b flows through exhaust path 136b and its kinetic energy drives a turbine 138b of turbocharger 114b, which in turn drives compressor 116b via a shaft 140b. Wastegate valves 141a, 141b regulate turbocharger speed/boost pressure.

The exhaust gas flows from turbines 138a, 138b through exhaust paths 142a, 142b and is treated by exhaust treatment systems (ETS) 144a, 144b to decrease or eliminate emissions before being released into the atmosphere. Non-limiting example components include gasoline particulate filters (GPFs), three-way catalytic converters (TWCs), and mufflers. It will be appreciated that each ETS 144a, 144b could include other exhaust treatment components. A low pressure EGR (LPEGR) system 146 recirculates exhaust gas from an EGR pickup point 147 downstream of ETS 144b through an EGR path 148 that is regulated by an EGR valve 150. The EGR path 148 splits into separate EGR paths 152a, 152b which direct the exhaust gas to ports in induction paths 112a, 112b downstream of the dP valve 110 and upstream of the compressors 116a, 116b. The LPCEGR system 146 also includes an EGR cooler (EGRC) 154 that cools the exhaust gas. Because turbocharged gasoline engines operate at very high temperatures, cooling of the recirculated exhaust gas could provide for increased performance. A controller 156 controls operation of the engine system 101. It will be appreciated that the term “controller” as used herein refers to any suitable control device or set of multiple control devices that is/are configured to perform at least a portion of the techniques of the present disclosure. Non-limiting examples include an application-specific integrated circuit (ASIC) and one or more processors and a non-transitory memory having instructions stored thereon that, when executed by the one or more processors cause the controller to perform a set of operations. The one or more processors could be a single processor or two or more processors operating in a parallel or distributed architecture.

Optional inlet air temperature and mass air flow (MAF) sensors 109, 111 measure intake air temperature and intake mass air flow. It will be appreciated that these sensors 109, 111 could also be arranged in other suitable positions of the induction system 104. An optional charge air temperature sensor 123 measures ACT at an outlet of the throttle valve 122. An optional EGRC outlet temperature sensor 155 measures a temperature of EGR at an outlet of the EGRC 154. The controller 156 includes a barometric pressure sensor 158 that measures barometric pressure. It will be appreciated that the barometric sensor 158 could be external to the controller 156. An EGR valve delta pressure sensor 160 is disposed proximate to the EGR valve 150 and measures a delta pressure across the EGR valve 150. A dP valve outlet pressure sensor 162 measures a pressure at an outlet of the dP valve 110. As previously mentioned, this dP valve outlet pressure also corresponds to inlet pressures of the compressors 116a, 116b. Lastly, exhaust gas concentration sensors 164a, 164b measure exhaust gas concentration. In one exemplary implementation, the exhaust gas concentration sensors 164a, 164b are WRO2 sensors configured to measure an air/fuel ratio (FA) of the exhaust gas. An accelerator pedal position sensor 170 also measures a position of an accelerator pedal (Accel. Pedal) 172 that is actuated by a driver of the vehicle 100. All of these sensors provide their measurements to the controller 156, e.g., via a controller area network (CAN, not shown). The controller 156 is also able to control the various valves and other devices/systems described herein, e.g., via the CAN. The controller 156 is also configured to implement at least a portion of the techniques of the present disclosure, which are now described in greater detail.

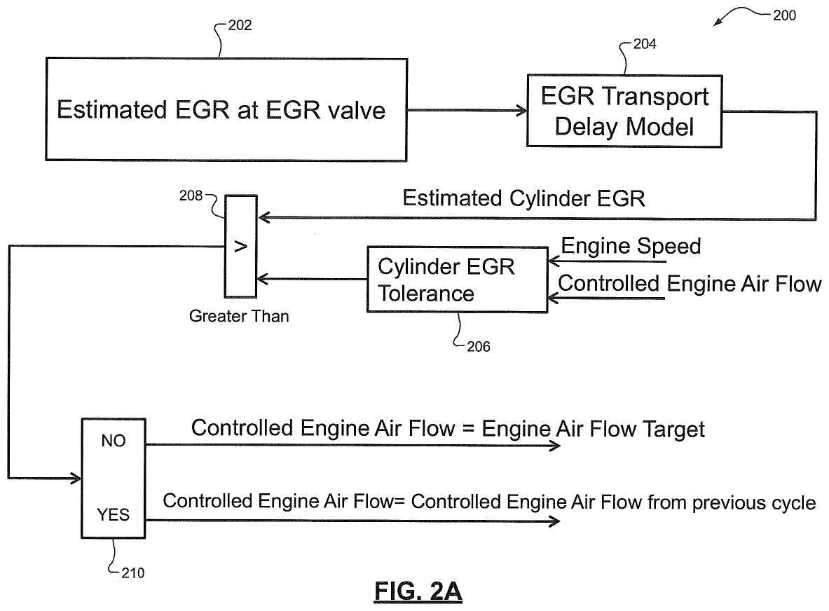

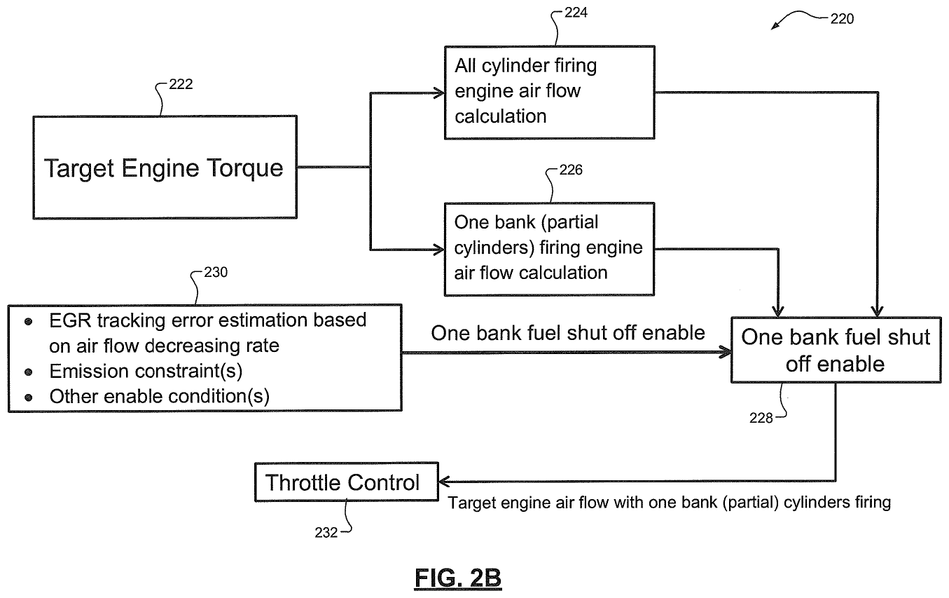

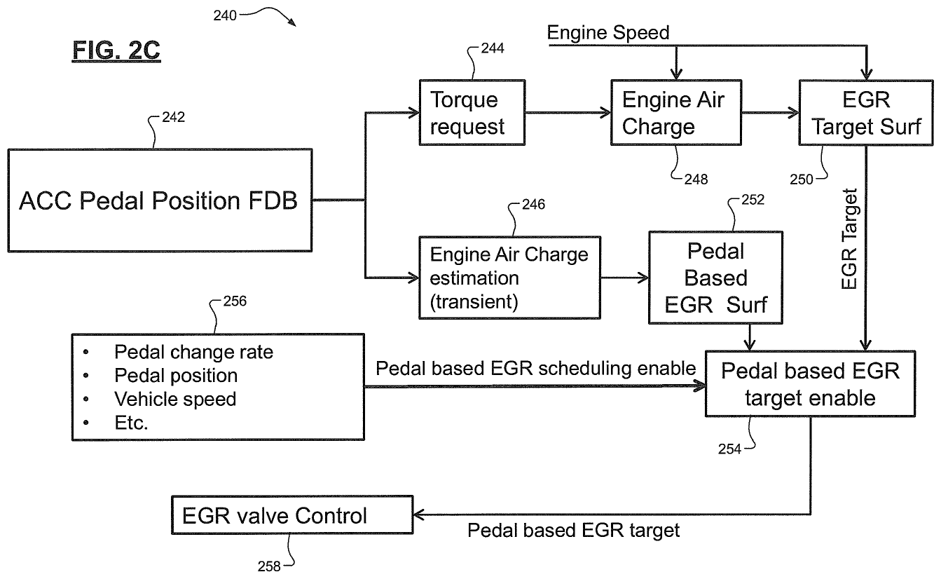

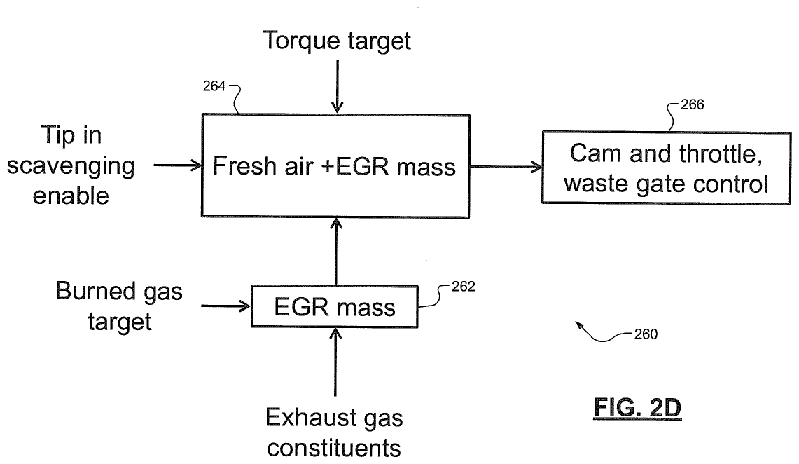

Referring now to FIGS. 2A-2D, functional block diagrams of example control architectures 200, 220, 240, and 260 for improving EGR tracking in engines having LPCEGR systems (e.g., engine system 101). It will be appreciated that each of these control architectures could be at least partially implemented by the controller 156.

Referring now to FIG. 2A, an air flow regulation architecture 200 is illustrated. At 202, the amount of EGR at the EGR valve 160 is estimated. At 204, the EGR amount is fed into an EGR transport delay model to produce an estimated amount of EGR at the cylinders 128. Based on engine speed and the controlled engine air flow, a cylinder EGR tolerance is determined at 206. This cylinder EGR tolerance generated/output by 206 is based on a calibration that presents the maximum EGR level without misfire issues. The cylinder EGR tolerance and the estimated cylinder EGR are both fed to 208 where it is determined whether the estimated cylinder EGR exceeds the cylinder EGR tolerance. When false, block 210 sets the controlled engine air flow to an engine air flow target. When true, however, block 210 sets the controlled engine air flow to the controlled engine air flow from a previous cycle. This previous cycle is an example of air flow regulation and the regulation algorithm could be optimized with a balance of misfire issues, torque accuracy, and fuel economy, to name a few parameters. In one implementation, the engine air mass is clipped to (1) faster deplete the current EGR and (2) make sure the engine airflow is not too low with a high level of EGR to get into misfire issues. This control architecture 200 could be limited, for example, to accelerator pedal tip-out where EGR over-delivery could occur. This architecture 200 could also be further optimized with a balance of misfire issues, torque accuracy, and fuel economy.

Referring now to FIG. 2B, a cylinder bank fuel shutoff architecture 220 is illustrated. At 222, target engine torque is determined and fed to both block 224 and 226. At 224, an all cylinder air flow calculation is performed based on the target engine torque. At 226, a partial cylinder (a single cylinder bank) air flow calculation is performed based on the target engine torque. At 228, one of these calculated air flows is selected depending on whether cylinder bank fuel shutoff has been enabled. At 230, it is determined whether to enable cylinder bank fuel shutoff based on parameters such as, but not limited to, EGR tracking error estimation based on the decreasing air flow rate and emissions constraints. The selected calculated air flow (all cylinders or partial cylinders) is then fed from 228 to 232 depending on whether cylinder bank fuel shutoff has been enabled. At 232, the throttle valve 122 is then controlled using the calculated air flow value as a target value. This control architecture 220 could be limited, for example, to accelerator pedal tip-out where EGR over-delivery could occur. Engine air mass is significantly increased (e.g., almost doubled) while providing the same output torque. This is because the deactivated cylinders still receive airflow but produce no torque due to the lack of fueling. In fact, the deactivated cylinders could produce negative torque. This large increase in engine air flow allows for EGR to be quickly depleted.

Referring now to FIG. 2C, an accelerator pedal-based EGR scheduling control architecture 240 is illustrated. At 242, the position of the accelerator pedal 172 is measured using accelerator pedal position sensor 170. This measured position is fed to both block 244 and block 246. At 244, an engine torque request is determined based on the measured position and a desired engine air charge is then determined at 248 based on the engine torque request and the engine speed. At 250, a target EGR surface is utilized to determine a target EGR level based on the engine speed and the desired engine air charge. At 246, a transient engine air charge estimation is performed based on the measured position. At 252, a pedal based EGR surface is utilized to determine a target EGR level based on the transient engine air charge estimation. Both of these target EGR levels are fed to block 254, which selects one of the target EGR levels to output depending on whether pedal based EGR scheduling is enabled. At 256, it is determined whether to enabled pedal based EGR scheduling based on parameters such as, but no limited to, a rate of change of the measured position, the measured position, and vehicle speed. The selected target EGR level is then fed to 258 where the EGR valve 150 is controlled according to the target EGR level. This control architecture 240 could be applicable to both accelerator pedal tip-in and tip-out by scheduling the EGR immediately and prior to other actuators such that the EGR is delivered faster and before the engine load actually increases or decreases.

Referring now to FIG. 2D, a scavenging control architecture 260 is illustrated. Scavenging refers to engine operation with intake valve and exhaust valve opening overlap such that additional fresh air is pushed into and through the cylinders 128 for increased power. A scavenging mode could be enabled or achieved, for example, using intake and exhaust control systems 133a, 133b. At 262, an EGR mass is estimated based on tracking of the exhaust gas constituents through the LPCEGR system 146 and a burned gas target. At 264, a total charge (fresh air+EGR mass) is determined based on a target engine torque, a tip-in scavenging enable signal, and the estimated EGR mass. In other words, this represents a coordinated control of both scavenging and EGR. This control architecture 260 could be limited, for example, to accelerator pedal tip-in events where under-delivery of EGR could occur. In this case, scavenging increases engine airflow during tip-in, which speeds up EGR delivery to the cylinders. At 266, at least one of camshafts, throttle valve, and wastegate valve control is performed based on the total charge.

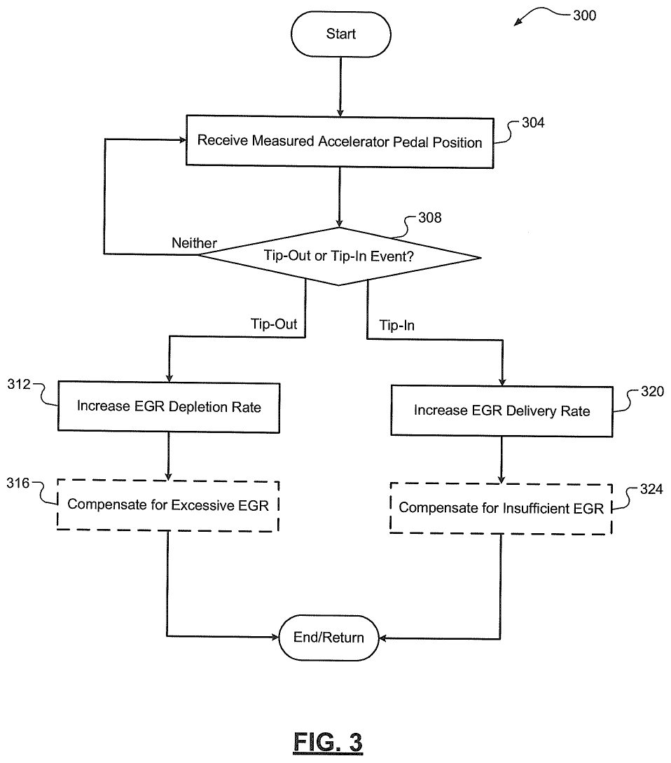

It will be appreciated that methods corresponding to the control architectures described above and illustrated in FIGS. 2A-2D, which could also be described sub-routines or sub-methods of a higher level of more generic method (see FIG. 3 and its description below) could be implemented by the controller 156.

Referring now to FIG. 3, a flow diagram of an example method 300 of controlling a turbocharged engine having an LPCEGR system is presented. While described with specific reference to the engine system 101 herein, it will be appreciated that this method 300 could be applicable to any turbocharged engine having an LPCEGR system and the other respective hardware previously discussed herein. At 304, the controller 156 receives, from the accelerator pedal position sensor 170, a measured position of the accelerator pedal 172. At 308, the controller 156 detects whether the measured accelerator pedal position is indicative of a transient tip-out event, a transient tip-in event, or neither. If neither, the method 300 ends or returns to 304. When the transient tip-out event is detected at 308, the method 300 proceeds to 312. At 312, the controller 156 controls the engine 102 to increase EGR depletion rate. This could include, for example, at least one of (i) controlling the throttle valve 122 to maintain at least a minimum airflow into the engine or to regulate a rate of decrease of the airflow into the engine 100, (ii) disabling fueling to one of the cylinder banks 129a, 129b, and (iii) controlling the EGR valve 150 to pre-schedule EGR based on the measured accelerator pedal position.

At optional 316, the controller 156 could temporarily compensate for excessive EGR by at least one of (i) optimizing intake/exhaust positions (e.g., lifts) to at least one of minimize in-cylinder residual gas and increase intake charge motion (e.g., for better air/fuel mixing and turbulence kinetics, which could help reduce engine misfires) and (ii) optimizing at least one of spark timing and spark energy via spark system 132. The method 300 then ends or returns to 304 for another cycle. When the transient tip-out event is detected at 308, the method 300 proceeds to 320. At 320, the controller 156 controls the engine 102 to increase EGR delivery rate. This could include, for example, at least one of (i) controlling the EGR valve 150 to pre-schedule EGR based on the measured accelerator pedal position and (ii) controlling intake/exhaust valves to enable a scavenging mode. At optional 324, the controller 156 could temporarily compensate for insufficient EGR by optimizing at least one of spark timing and spark energy via spark system 132. The method 300 then ends or returns to 304 for another cycle.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for a turbocharged engine having a low pressure cooled exhaust gas recirculation (LPCEGR) system configured to provide EGR to an induction system of the engine via an EGR port, the control system comprising:
an accelerator pedal position sensor configured to measure a position of an accelerator pedal of a vehicle comprising the engine; and
a controller configured to detect a transient tip-out event or a transient tip-in event based on the measured accelerator pedal position and:
in response to detecting the transient tip-out event, temporarily increase an EGR depletion rate by at least one of:
(i) controlling a throttle valve arranged downstream from the EGR port to maintain at least a minimum airflow into the engine or to regulate a rate of decrease of the airflow into the engine,
(ii) disabling fueling to a first cylinder bank of the engine, and
(iii) controlling an EGR valve of the LPCEGR system to pre-schedule EGR based on the measured accelerator pedal position; and
in response to detecting the transient tip-in event, temporarily increase an EGR delivery rate by at least one of:
(i) controlling the EGR valve to pre-schedule EGR based on the measured accelerator pedal position, and
(ii) controlling intake/exhaust valves of cylinders of the engine to enable a scavenging mode.

2. The control system of claim 1, wherein in response to detecting the transient tip-out event, the controller is further configured to temporarily compensate for excessive EGR by at least one of:
(i) optimizing intake/exhaust camshaft positions to at least one of minimize in-cylinder residual gas and increase intake charge motion for better air/fuel mixing and turbulence kinetics; and
(ii) optimizing at least one of spark timing and spark energy.

3. The control system of claim 1, wherein in response to detecting the transient tip-in event, the controller is further configured to temporarily compensate for insufficient EGR by optimizing at least one of spark timing and spark energy.

4. The control system of claim 1, wherein the controller is configured to disable fueling to the first cylinder bank of the engine while still allowing airflow through the first cylinder bank and also maintaining fueling to a different second cylinder bank.

5. The control system of claim 1, wherein the controller is configured to control the EGR valve to pre-schedule EGR based on the measured accelerator pedal position in advance of one or more other engine flow-control actuators.

6. The control system of claim 1, wherein the controller is configured to temporarily increase the EGR depletion rate in response to detecting the transient tip-out event to at least one of (i) maintain or increase combustion quality/stability and (ii) mitigate or prevent engine misfires.

7. The control system of claim 1, wherein the controller is configured to temporarily increase the EGR delivery rate in response to detecting the transient tip-in event to at least one of (i) mitigate or prevent pre-ignition/knock and (ii) maintain or increase engine fuel economy.

8. The control system of claim 1, wherein the controller is configured to temporarily increase the EGR depletion rate in response to detecting the transient tip-out event by:
(i) controlling the throttle valve to maintain at least the minimum airflow into the engine or to regulate the rate of decrease of the airflow into the engine;
(ii) disabling fueling to the first cylinder bank of the engine; and
(iii) controlling the EGR valve to pre-schedule EGR based on the measured accelerator pedal position.

9. The control system of claim 1, wherein the controller is configured to temporarily increase the EGR delivery rate in response to detecting the transient tip-in event by:
(i) controlling the EGR valve to pre-schedule EGR based on the measured accelerator pedal position; and
(ii) controlling the intake/exhaust valves of the cylinders of the engine to enable the scavenging mode.

10. A control method for a turbocharged engine having a low pressure cooled exhaust gas recirculation (LPCEGR) system configured to provide EGR to an induction system of the engine via an EGR port, the method comprising:
receiving, by a controller of the engine and from an accelerator pedal position sensor, a measured position of an accelerator pedal of a vehicle comprising the engine;
detecting, by the controller, a transient tip-out event or a transient tip-in event based on the measured accelerator pedal position;
in response to detecting the transient tip-out event, temporarily increase an EGR depletion rate by at least one of:
(i) controlling a throttle valve arranged downstream from the EGR port to maintain at least a minimum airflow into the engine or to regulate a rate of decrease of the airflow into the engine,
(ii) disabling fueling to a first cylinder bank of the engine, and
(iii) controlling an EGR valve of the LPCEGR system to pre-schedule EGR based on the measured accelerator pedal position; and
in response to detecting the transient tip-in event, temporarily increase an EGR delivery rate by at least one of:
(i) controlling the EGR valve to pre-schedule EGR based on the measured accelerator pedal position, and
(ii) controlling intake/exhaust valves of cylinders of the engine to enable a scavenging mode.

11. The method of claim 10, further comprising in response to detecting the transient tip-out event, temporarily compensating for excessive EGR, by the controller, by at least one of:
(i) optimizing intake/exhaust camshaft positions to at least one of minimize in-cylinder residual gas and increase intake charge motion for better air/fuel mixing and turbulence kinetics; and
(ii) optimizing at least one of spark timing and spark energy.

12. The method of claim 10, further comprising in response to detecting the transient tip-in event, temporarily compensating for insufficient EGR. by the controller, by optimizing at least one of spark timing and spark energy.

13. The method of claim 10, wherein disabling fueling to the first cylinder bank of the engine further comprises still allowing airflow through the first cylinder bank and also maintaining fueling to a different second cylinder bank.

14. The method of claim 10, wherein controlling the EGR valve to pre-schedule EGR based on the measured accelerator pedal position is performed in advance of one or more other engine flow-control actuators.

15. The method of claim 10, wherein temporarily increasing the EGR depletion rate in response to detecting the transient tip-out event is performed to at least one of (i) maintain or increase combustion quality/stability and (ii) mitigate or prevent engine misfires.

16. The method of claim 10, wherein temporarily increasing the EGR delivery rate in response to detecting the transient tip-in event is performed to at least one of (i) mitigate or prevent pre-ignition/knock and (ii) maintain or increase engine fuel economy.

17. The method of claim 10, wherein temporarily increasing the EGR depletion rate in response to detecting the transient tip-out event comprises:
(i) controlling the throttle valve to maintain at least the minimum airflow into the engine or to regulate the rate of decrease of the airflow into the engine;
(ii) disabling fueling to the first cylinder bank of the engine; and
(iii) controlling the EGR valve to pre-schedule EGR based on the measured accelerator pedal position.

18. The method of claim 10, wherein temporarily increasing the EGR delivery rate in response to detecting the transient tip-in event comprises:
(i) controlling the EGR valve to pre-schedule EGR based on the measured accelerator pedal position; and
(ii) controlling the intake/exhaust valves of the cylinders of the engine to enable the scavenging mode.
